(19) United States
(12) Patent Application Publication
(10) Pub. No.: US 2009/0208229 A1
(43) Pub. Date: Aug. 20, 2009

(54) Image Forming Apparatus

(75) Inventors: Osamu TAKAGI, Nagoya-shi (JP); Takayuki SAKAI, Gifu-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/369,772

(22) Filed: Feb. 12, 2009

(30) Foreign Application Priority Data
Feb. 15, 2008 (JP) 2008-034758

(51) Int. Cl. G03G 15/00

(52) U.S. Cl. 399/43; 399/44

(57) ABSTRACT

An image forming apparatus includes an endless belt which is wound around a plural rollers and conveys a recording medium in a conveying direction; a plurality of image forming units which sequentially form images on the recording medium conveyed by the endless belt in an overlap manner; a fixing unit which is provided at a downstream of the endless belt in the conveying direction; a first detection unit which detects a temperature of a roller closest to the fixing unit; a second detection unit which detects a temperature of the endless belt; an error calculation unit which calculates an error of a conveying speed of the recording medium based on a difference between the detected temperatures, and a number of a recording medium, on which images are next to be formed; and a compensation unit which compensates the error calculated by the error calculation unit.

### CROSS-REFERENCE TO RELATED APPLICATION

This application claims priority from Japanese Patent Application No. 2008-034758, filed on Feb. 15, 2008, the entire subject matter of which is incorporated herein by reference.

### TECHNICAL FIELD

Aspects of the present invention relate to an image forming apparatus that forms an image on a recording medium, and in particular, to an image forming apparatus that conveys a recording medium by an endless belt and sequentially forms images on the recording medium in an overlap manner by image forming units, which are provided for respective colors.

### BACKGROUND

An image forming apparatus, for example, a direct transfer color printer of tandem type, has been suggested which conveys a recording medium, such as a sheet, by an endless belt and sequentially forms images on the recording medium in an overlap manner by image forming units provided for respective colors. In such an image forming apparatus, a fixing unit is provided on a more downstream side in a conveying direction of the recording medium than the endless belt so as to thermally fix the images formed by the image forming units to the recording medium.

When such a fixing unit is provided, a roller closest to the fixing unit from among rollers, around which the endless belt is wound, is heated by heat generated from the fixing unit, and while the endless belt is being rotationally driven, the endless belt may thermally expand and contract. When this happens, the images of the respective colors to be formed by the image forming units may be shifted from desired locations on the recording medium, that is, so-called color shift may occur. Accordingly, there is suggested a method that detects the temperature of each portion of the endless belt, calculates the color shift amount on the basis of a temperature difference, and corrects image forming timing for each color (for example, see JP-A-2005-43863).

In recent years, in such an image forming apparatus, high-speed image formation is developed. When images are successively formed a plurality of recording media, the temperature of each portion varies constantly. The endless belt is affected by such temperature of each portion varying constantly. As a result, the thermal expansion and contraction of the endless belt vary constantly.

### SUMMARY

Exemplary embodiments of the present invention address the above disadvantages and other disadvantages not described above. However, the present invention is not required to overcome the disadvantages described above, and thus, an exemplary embodiment of the present invention may not overcome any of the problems described above.

Accordingly, it is an aspect of the present invention to provide an image forming apparatus that can reduce or suppress occurrence of color shift due to thermal expansion and contraction of an endless belt even while the endless belt is affected by the temperature of each portion varying constantly.

According to an exemplary embodiment of the present invention, there is provided an image forming apparatus including: an endless belt which is wound around a plurality of rollers and conveys a recording medium in a conveying direction, at least one of the plurality of rollers being rotationally driven; a plurality of image forming units which are provided for respective colors and sequentially form images on the recording medium conveyed by the endless belt in an overlap manner; a fixing unit which is provided at a downstream of the endless belt in the conveying direction, and thermally fixes the images formed by the image forming units to the recording medium; a first detection unit which detects a temperature of a roller closest to the fixing unit among the plurality of rollers; a second detection unit which detects a temperature of the endless belt; an error calculation unit which calculates an error of a conveying speed of the recording medium based on a difference between the detected temperatures by the first detection unit and the second detection unit immediately before the image forming units start image formation, and a number of a recording medium, on which images are next to be formed, from the start of the image formation; and a compensation unit which compensates the error calculated by the error calculation unit.

According to another exemplary embodiment of the present invention, there is provided an image forming apparatus including: an endless belt which is wound around a plurality of rollers and conveys a recording medium in a conveying direction; an image forming unit which forms an image on the recording medium conveyed by the endless belt; a fixing unit which thermally fixes the image formed on the recording medium; a first detection unit which is provided in a vicinity of a first roller closest to the fixing unit among the plurality of rollers and which detects a temperature of air in the vicinity of the first roller; a second detection unit which is provided at a position farther from the fixing unit than the first detection unit, and which detects a temperature of air in a vicinity of the endless belt; a controller which controls a position of an image formed on the recording medium by the image forming unit based on a difference between the detected temperatures by the first detection unit and the second detection unit immediately before the image forming unit starts image formation and based on a number of the recording medium, on which an image is next to be formed by the image forming unit, from the start of the image formation.

### BRIEF DESCRIPTION OF THE DRAWINGS

The above and other aspects of the present invention will become more apparent and more readily appreciated from the following description of exemplary embodiments of the present invention taken in conjunction with the attached drawings, in which:

FIG. 1 is a side sectional view showing the schematic configuration of an image forming apparatus according to an exemplary embodiment of the present invention;

FIG. 2 is a block diagram showing the configuration of a control system of the image forming apparatus;

FIG. 3 is an explanatory view showing a change in an error of a sheet conveying speed when a large temperature difference occurs between a belt driving roller and a convey belt in the image forming apparatus;

FIG. 4 is a flowchart showing a process which is executed by the control system of the image forming apparatus;

FIG. 5 is a flowchart showing a modification of the process of FIG. 4; and

FIG. 6 is a graph showing a result of an experiment for examining a change in a relation between a number of sheets and an error of a sheet conveying speed as temperature difference varies.

### DETAILED DESCRIPTION

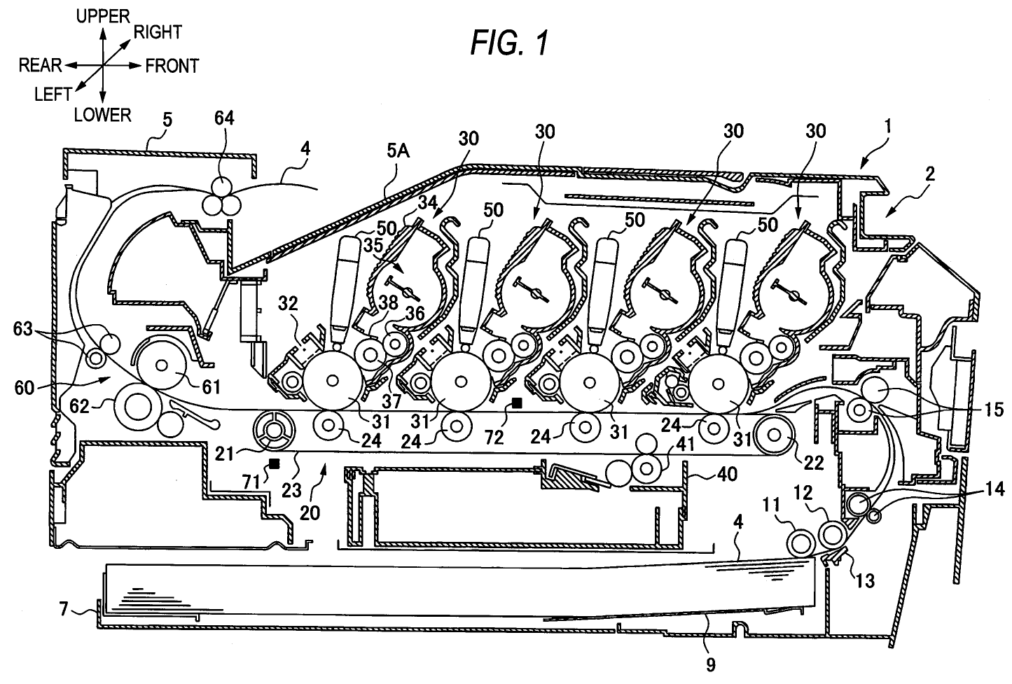

Exemplary embodiments of the present invention will now be described with reference to the drawings. FIG. 1 is a side sectional view showing the schematic configuration of an image forming apparatus 1 according to an exemplary embodiment.

In the following description, in FIG. 1, the right side of the sheet is referred to as “front”; the left side is referred to as “rear”; a direction away from the viewer of the sheet is referred to as “right”; and a direction toward the viewer is referred to as “left.” The vertical direction of the sheet is referred to as the “upper and lower direction.”

(Overall Configuration of Image Forming Apparatus)

The image forming apparatus 1 is a direct transfer color printer of tandem type and includes a box-like housing 2 as shown in FIG. 1. The housing 2 is provided with a sheet discharging tray 5A, on which a sheet 4 as a recording medium having formed images thereon is stacked, at the top surface thereof. A top cover 5 is provided rotatably about a rear-side upper end of the image forming apparatus 1. The top cover 5 is formed integrally with the sheet discharging tray 5A as a single body and configured to cover the image forming apparatus 1 from above. In a state where the top cover 5 is open, a belt unit 20 which will be described below can be removed upward from the inside of the housing 2.

A sheet feeding tray 7 in which the sheet 4 for forming images is stacked is mounted at a lower part of the housing 2 removably to forward. A sheet pressing plate 9 that is obliquely movable so as to move up the front end of the sheet 4 is provided in the sheet feeding tray 7. A feed roller 11 that conveys the sheet 4 is provided at an upper position of the front end of the sheet feeding tray 7. A separation roller 12 and a separation pad 13 that separate the sheets 4 to be conveyed by the feed roller 11 one by one are provided on a downstream side in a sheet conveying direction by the feed roller 11.

The uppermost sheet 4 in the sheet feeding tray 7 is separated by the separation roller 12, is conveyed by a pair of convey rollers 14, and is fed to a register roller 15. The register roller 15 feeds the sheet 4 to the belt unit 20 at rear side with a predetermined timing.

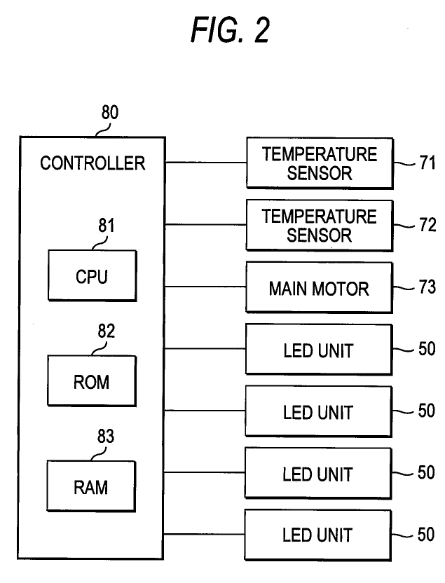

The belt unit 20 is detachably provided to the housing 2, and includes a convey belt 23 that is horizontally wound around a belt driving roller 21 and a tension roller 22, which are disposed to be away from each other in a front-rear direction. The convey belt 23 is an endless belt made of a resin material, such as polycarbonate. When the rear-side belt driving roller 21 is rotationally driven by a main motor 73 (see FIG. 2), the convey belt 23 is rotated in a counterclockwise direction of FIG. 1, and conveys the sheet 4 placed on an upper surface thereof (hereinafter, referred to as a conveying surface) to the rear side. The tension roller 22 is provided such that a rotational shaft thereof is in parallel to the belt driving roller 21, and is pressed forwardly by a spring (not shown) to apply adequate tension to the convey belt 23.

(Configuration of Image Forming Unit)

Inside the convey belt 23, four transfer rollers 24 are arranged at regular intervals in a front-rear direction to be opposed to photosensitive drums 31 of image forming units 30 which will be described below. The convey belt 23 is sandwiched between each photosensitive drum 31 and the corresponding transfer roller 24. When a toner image which will be described below is transferred, a transfer bias is applied between the transfer roller 24 and the photosensitive drum 31, and a predetermined amount of transfer current flows. A related-art belt cleaner 40 is provided below the belt unit 20 so as to remove toner or paper dust adhering to the convey belt 23 by a cleaning roller 41.

Four image forming units 30 which are paired with LED units 50 are provided in series in an order of black, yellow, magenta, and cyan from the upstream side along the sheet conveying direction. The image forming unit 30, the LED unit 50, and the transfer roller 24 for each color.

Each image forming unit 30 includes a photosensitive drum 31 serving as an image carrier, a scorotron-type charger 32, a developing cartridge 34 serving as a developing device, and the like. The photosensitive drum 31 includes a grounded metallic drum body and is coated with a positively chargeable photosensitive layer made of polycarbonate on the surface of the metallic drum body. The scorotron-type charger 32 is opposed to the photosensitive drum 31 behind and above the photosensitive drum 31 with a predetermined gap therebetween so as not to come into contact with the photosensitive drum 31. The scorotron-type charger 32 causes a charging wire, such as tungsten, to generate corona discharge, and positively charges the surface of the photosensitive drum 31 uniformly.

The developing cartridge 34 has a box shape and has a toner containing chamber 35 at an upper part thereof. The developing cartridge 34 also has a supply roller 36, a developing roller 37, and a layer thickness regulating blade 38 on a lower side thereof. The toner containing chamber 35 of the developing cartridge 34 stores positively chargeable, non-magnetic one component toner serving as developer for each of black, cyan, magenta, and yellow.

Toner ejected from the toner containing chamber 35 is supplied to the developing roller 37 by rotation of the supply roller 36, and is frictionally positively charged between the supply roller 36 and the developing roller 37. Toner supplied onto the developing roller 37 enters and sufficiently frictionally charged between the layer thickness regulating blade 38 and the developing roller 37 by rotation of the developing roller 37, and is carried on the developing roller 37 in the form of a thin layer at a predetermined thickness.

When rotating, the surface of the photosensitive drum 31 is first positively charged uniformly by the scorotron-type charger 32. Next, exposure is carried out by LEDs (not shown) which are provided at a lower end of the LED unit 50 in a line in a sheet width direction (in the left and right direction). Thus, an electrostatic latent image corresponding to an image to be formed on the sheet 4 is formed.

The toner which is carried on the developing roller 37 and positively charged is opposed to and comes into contact with the photosensitive drum 31 when the developing roller 37 is rotated, and is supplied to the electrostatic latent image which is formed on the surface of the photosensitive drum 31. Thus, the electrostatic latent image of the photosensitive drum 31 is visualized, and a toner image in which toner is stuck only to an exposed portion is carried on the surface of the photosensitive drum 31.

Subsequently, toner images formed on the surfaces of respective photosensitive drum 31 are sequentially transferred to the sheet 4 in overlap manner by the transfer current when the sheet 4 to be conveyed by the convey belt 23 passes through between the photosensitive drums 31 and the transfer rollers 24. The sheet 4, to which the toner images for the respective colors are sequentially transferred in an overlap manner, is conveyed to a fixing device 60.

The fixing device 60 is disposed at the rear of the convey belt 23 inside the housing 2. That is, the fixing device 60 is disposed more downstream than the convey belt 23 in the sheet conveying direction. The fixing device 60 includes a heating roller 61 that has a heat source, such as a halogen lamp, and is rotationally driven, and a pressing roller 62 that is disposed below the heating roller 61 so as to be opposed to the heating roller 61 and press the heating roller 61 and is rotated by rotation of the heating roller 61. The fixing device 60 heats the sheet 4, to which the toner images of the respective colors are transferred, while the heating roller 61 and the pressing roller 62 sandwich and convey the sheet 4. Thus, the toner images are fixed to the sheet 4. The sheet 4 on which the toner images are fixed is conveyed by a convey roller 63, which is disposed behind and above the fixing device 60, and is discharged onto the above-described sheet discharging tray 5A by a discharge roller 64, which is provided at an upper part of the housing 2.

A temperature sensor 71 is provided in the vicinity of the belt driving roller 21, more particularly, immediately below the belt driving roller 21. The temperature sensor 71 detects the temperature of the belt driving roller 21. The convey belt 23 is most affected by the temperature of the fixing device 60 at this portion around the belt driving roller 21. A temperature sensor 72 is provided around the center of the convey belt 23 further away from the fixing device 60 than the temperature sensor 71. More particularly, the temperature sensor 72 is provided immediately above the conveying surface of the convey belt 23 in the middle of the photosensitive drums 31 corresponding to yellow and magenta which are the second and third colors from the upstream side in the sheet conveying direction. The temperature sensor 72 detects the temperature of the convey belt 23. The position where the temperature sensor 72 is provided is almost center of the housing 2, and therefore, the temperature at the position is stable in the housing 2. Thus, at this position, the temperature of the convey belt 23 becomes smallest in the housing 2. The temperature sensor 72 may be provided at any position which can detect the temperature of the convey belt 23 and is farther from the fixing unit than the temperature sensor 71.

It is noted that the temperature sensors 71 and 72 may be configured by a thermocouple, a thermistor or a thermopile.

Since the convey belt 23 has a small heat capacity and a high heat conductivity, the temperature of the convey belt 23 becomes always substantially equal to the temperature of air in the vicinity of the convey belt 23. Therefore, even in a case where the temperature of the convey belt 23 is detected while the temperature sensors 71 and 72 are not in contact with the convey belt 23, if air in the vicinity of a portion of the convey belt 23, a detection value, which can be regarded as the temperature of such portion of the convey belt 23, can be obtained.

According to the above configuration in which the temperature sensors 71 and 72 detect the temperature of air in the vicinity of the convey belt 23, the temperature sensors 71 and 72 can be arranged with a gap between the temperature sensors 71 and 72, and the convey belt 23. Since the temperature sensors 71 and 72 are not in contact with the convey belt 23, it can be prevented that the temperature sensors 71 and 72 or the convey belt 23 is damaged by friction. In other words, the temperature sensors 71 and 72, and the convey belt 23 are not hurt or abraded by slidable contact with each other.

The temperature sensors 71 and 72 are provided separately from the belt unit 20, and thus the temperature sensors 71 and 72 remain inside the main body of the image forming apparatus 1 even if the belt unit 20 is replaced.

(Configuration of Control System of Image Forming Apparatus)

FIG. 2 is a block diagram showing the configuration of a control system of the image forming apparatus 1 having the above-described configuration. As shown in FIG. 2, the temperature sensors 71 and 72 are connected to a controller 80, together with the main motor 73 for driving the belt driving roller 21 and the four LED units 50 for the respective colors. The controller 80 is formed by a microcomputer including a central processing unit (CPU) 81, a read only memory (ROM) 82, and a random access memory (RAM) 83, and controls the main motor 73 and the LED units 50 based on programs stored in the ROM 82. Although the controller 80 further includes various driving circuit and buffers, these driving circuits and buffer are known and thus illustrations and descriptions thereof will be omitted.

(Control by Control System)

Next, from among control processes to be executed by the controller 80, a control process based on the detection temperatures by the temperature sensors 71 and 72 will be described. When a large difference between the detection temperatures by the temperature sensors 71 and 72 exists, that is, when a significant difference between the temperature of the belt driving roller 21 and the temperature of the convey belt 23 exists, if the individual parts are driven as usual and image formation is carried out on the sheet 4 (hereinafter, referred to as printing), the following situation could be caused.

For example, if successive printing is performed for a specific time, the temperature of the fixing device 60 becomes high, and when printing is stopped, the belt driving roller 21 is heated by heat from the fixing device 60 and a significant difference in temperature between the belt driving roller 21 and the convey belt 23 occurs. In this state, if printing is resumed, a portion of the convey belt 23 which comes into contact with the belt driving roller 21 is locally heated, and the convey belt 23 at this portion expands. For this reason, the convey belt 23 may be loosened. Since the convey belt 23 is applied with tension from the tension roller, the convey belt 23 that is locally loosened is pulled to a side of the tension roller. Accordingly, the speed of the conveying surface of the convey belt 23, that is, the conveying speed of the sheet 4 decreases, as compared with the usual state.

Due to a change in the conveying speed, the toner images for the respective colors are shifted from desired locations of the sheet 4 and transferred. That is, so-called color shift occurs. It is noted that the heat of the belt driving roller 21 is lost by the convey belt 23 and the belt driving roller 21 gradually decreases in temperature, and if five sheets 4 are successively printed, an influence of an error in the conveying speed becomes negligible.

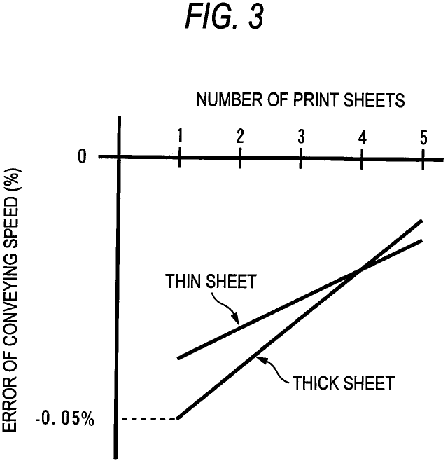

FIG. 3 is an explanatory view showing a change in an error of a conveying speed. As shown in FIG. 3, when the sheet 4 is thick, the error of the conveying speed when the first sheet is printed −0.05% (that is, delayed by 0.05%), and as the second sheet, the third sheet, . . . are successively printed, the error (absolute value) decreases. Finally, when the fifth sheet is printed, an influence of the error is negligible. When the sheet 4 is thin, the error of the conveying speed when the first sheet is printed is small, as compared with a case in which the sheet 4 is thick, but the decrease amount of the error as printing becomes small. The inventors have considered that this is because the heat capacity and stiffness of the sheet 4 varies in accordance with the thickness, and an influence on the change in temperature of the convey belt 23 or an influence of expansion and contraction of the convey belt 23 on the conveying speed of the sheet 4 also varies. It has been also considered that when the size of the sheet 4 varies, similar change is observed. When any sheet 4 is used, regardless of thick or thin, if five sheets are printed, the influence of the error becomes negligible.

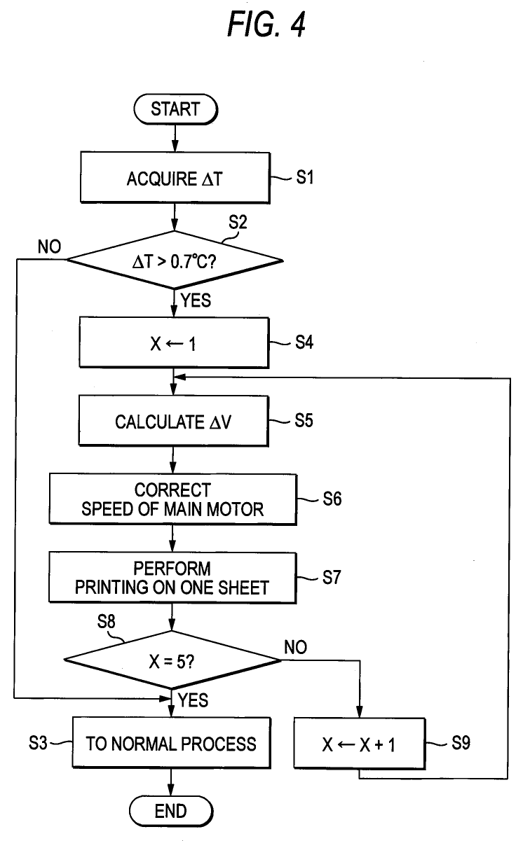

In this exemplary embodiment, the following control process is executed so as to compensate the error and reduce color shift. FIG. 4 is a flowchart showing a process to be executed by the CPU 81 based on the programs stored in the ROM 82 when image data is input from a personal computer (not shown) and an instruction to execute printing is input.

As shown in FIG. 4, at first of this process, at operation S1, the temperature difference ΔT (=T1−T2) is calculated, wherein T1 and T2 are temperatures detected by the temperature sensors 71 and 72, respectively. Next, at operation S2, it is determined whether the temperature difference ΔT is equal to or more than 0.7° C. If the temperature difference ΔT is less than 0.7° C. (S2: No), the process proceeds to operation S3, and the temperature difference ΔT is ignored. Then, a normal process is executed, in which the main motor 73 and the LED units 50 are controlled as usual, and the process ends.

If the temperature difference ΔT is equal to or more than 0.7° C. (S2: Yes), the process proceeds to operation S4, and 1 is set to a variable X. The variable X denotes the number of sheets to be printed next. Next, at operation S5, the error ΔV(%) of the conveying speed is calculated by the following Expression (1).

$$\begin{matrix}\begin{matrix}Δ V = ( a \cdot X - b ) \cdot Δ T + c \cdot X + d \\ = ( a \cdot Δ T - c ) \cdot X + ( d - b \cdot Δ T )\end{matrix} & ( 1 )\end{matrix}$$

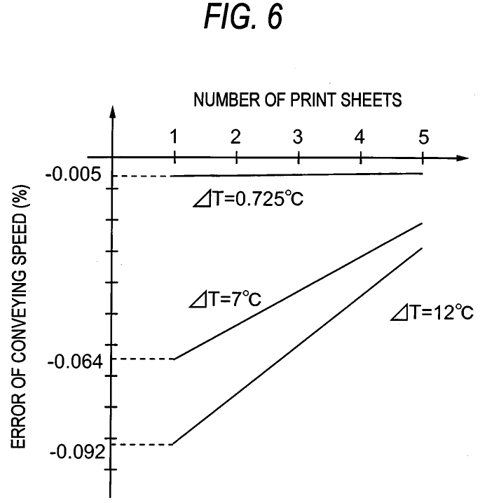

Here, ΔT is the temperature difference (° C.), and a, b, c, and d are constants obtained by an experiment in accordance with the thickness and size of the sheet 4 and stored in a table (not shown) in advance. It is noted that a, b, and c are positive constants, and the constant d is positive or negative and may be 0. FIG. 6 is a graph showing a result of an experiment for examining a change in a relation between variable X and the error ΔV as ΔT varies. As shown in FIG. 6, if ΔT is equal to or less than 0.725° C., it is found that the error ΔV becomes sufficiently small to be ignored. It is noted that ΔV is a delay generated since the speed of the conveying surface of the convey belt 23, that is, the conveying speed of the sheet 4 decreases due to a locally loosened portion of the convey belt 23 being pulled to a side of the tension roller. Therefore, ΔV is always less than 0.

In this exemplary embodiment, the error compensation based on the Expression (1) is performed only in the case where X is in a region in which ΔV is less than 0 and ΔT is larger than 0.7° C. for safe. (see operation S8 which will be described below).

Next, at operation S6, the speed of the main motor 73 is corrected so as to compensate (cancel) the error ΔV calculated at operation S5. For example, if the error ΔV is calculated to be −0.05%, the speed of the main motor 72 is increased by +0.05%. Subsequently, at operation S7, one sheet 4 is fed from the register roller 15, and printing is performed on the sheet 4. Next, at operation S8, it is determined whether the condition X=5 is satisfied. If X≠5 (S8: No), at operation S9, the variable X is incremented by 1, and the process returns to operation S5.

At operations S5 to S9 are repeatedly executed in the above-described manner, with respect to the five sheets after printing starts, the error ΔV can be calculated (S5), and the speed of the main motor 73 can be corrected for each sheet so as to compensate the error ΔV (S6). If the condition X=5 is satisfied (S8: Yes), the process proceeds to S3, and from the sixth sheet 4 and later, printing is normally performed. That is, from the sixth sheet and later, a control process when the condition ΔV=0 is satisfied is executed.

As described above, in this exemplary embodiment, the error ΔV is calculated based on the temperature difference ΔT immediately before printing starts, and the number of a sheet 4 to be next printed (the variable X). In order to calculate the error ΔV, constants that are set in accordance with the thickness and size of the sheet 4 are used. For this reason, even if no sensor is provided to the belt unit 20 which is replaced together with the convey belt 23, the error ΔV varying constantly can be sufficiently compensated, and occurrence of color shift can be sufficiently reduced. With respect to the thickness and size which are referred to when the constants are extracted, identification information of the sheet 4 which is input together with image data from a personal computer may be referred to, or an input from an operation panel may be read. In addition, the thickness and size may be detected by a sensor. The thickness and size can be appropriately acquired by known methods.

(Other Exemplary Embodiments)

While the present invention has been shown and described with reference to certain exemplary embodiments thereof, it will be understood by those skilled in the art that various changes in form and details may be made therein without departing from the spirit and scope of the invention as defined by the appended claims.

For example, although in the foregoing exemplary embodiment, the error ΔV is calculated for each sheet and the speed of the main motor 73 is corrected (S5 and S6), when a plurality of sheets 4 are placed on the convey belt 23 at the same time, the error ΔV may be calculated for every predetermined timing, and the speed of the main motor 73 may be corrected accordingly. In this case, if the variable X is increased by a predetermined rational number corresponding to the number of printed sheets for the predetermined time, the Expression (1) can be used unchanged.

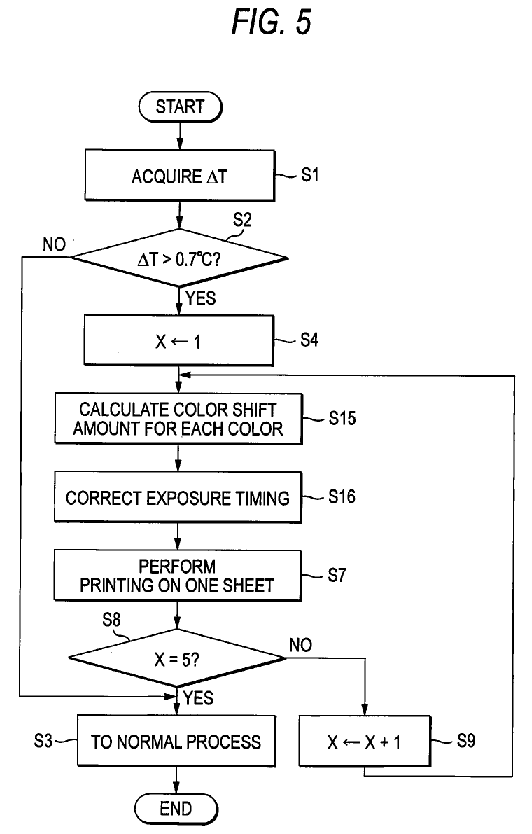

Although in the foregoing exemplary embodiment, color shift is reduced by adjusting the speed of the convey belt 23, color shift may be reduced by adjusting the exposure timing of the photosensitive drums 31 by the LED units 50. FIG. 5 is a flowchart showing a process in the controller 80 when color shift is reduced in such a manner. This process is similar to the process of FIG. 4, except that, instead of S5 and S6, S15 and S16 are executed, respectively. Therefore, only the difference will be described.

That is, during this process, after operations S4 or S9, the variable X is set in the above-described manner, at operation S15, the color shift amount is calculated by the following Expression (2). In the following Expression (2), C denotes the color shift amount (dot) of cyan with respect to black, M denotes the color shift amount (dot) of magenta with respect to black, and Y denotes the color shift amount (dot) of yellow with respect to black.

C=(a1·X−b1)·ΔT−c1·X+d1

M=0.67C

Y=0.33C (2)

Here, ΔT is the temperature difference (° C.) between the detection temperatures, and a1, b1, c1, and d1 are constants obtained by an experiment in accordance with the thickness and size of the sheet 4 and stored in a table (not shown) in advance. It is noted that a1, b1, and c1 are positive constants, and the constant d1 is positive or negative and may be 0. Similarly to the foregoing exemplary embodiment, the error compensation based on the Expression (2) is performed only in the case where X is in a region in which C is less than 0 and ΔT is larger than 0.7° C. for safe. (see operation S8).

That is, if it is assumed that the color shift amount between black on the uppermost stream side in the sheet conveying direction and cyan on the downmost stream side obtained by an expression similar to the Expression (1), is C, the color shift amount M between black and magenta and the color shift amount Y between black and yellow are ⅔ and ⅓ of the color shift amount C, respectively.

Next, at operation S16, the exposure timing of the LED units 50 is corrected so as to compensate (cancel) the color shift amounts C, M, and Y calculated at operation S15, and the process proceeds to operation S7. During this process, with respect to printing from the sixth sheet and later (S8: Yes), a control process (normal process) when the condition C=M=Y=0 is satisfied is executed (S3). Like the foregoing exemplary embodiment, when the speed of the convey belt 23 is adjusted, the errors ΔV for the respective colors can be collectively compensated, but the adjustment of the exposure timing as in this exemplary embodiment can be easily and rapidly performed by software.

Although in the foregoing exemplary embodiment, the error ΔV or the color shift amounts C, M, and Y are calculated while printing is being performed, these numerical values may be set in the form of a table, and a value corresponding to the temperature difference ΔT may be read out from the table. However, the foregoing expressions are simple primary expressions, and thus a processing load can be reduced. Although in the foregoing exemplary embodiment, the belt driving roller 21 is provided to be close to the fixing device 60, the tension roller 22 may be provided to be close to the fixing device 60. In this case, the temperature sensor 71 is provided in the vicinity of the tension roller 22. In addition, the tension roller 22 may be provided as a fixed driven roller, and a new tension roller may be provided to press the center of the convey belt 23 in the front-rear direction downwardly from the inside.

The error ΔV or the color shift amounts C, M, and Y calculated in the above-described manner may be applied to a so-called auto-registration operation to form a patch pattern in the convey belt 23 and to perform color matching, as well as a case in which printing is actually performed on the sheet 4. In this case, the final correction amount may be calculated by adding the error ΔV or the color shift amount C, M, and Y obtained based on the temperature difference ΔT to the color shift amount detected from the patch pattern.

In the foregoing exemplary embodiment, the direct transfer color printer is described, however the inventive concept of the present invention can be applied to a printer which employs intermediate transfer method in which an image is transferred from a photosensitive drum to an intermediate medium and the image is further transferred to a sheet.

The present invention provides illustrative non-limiting embodiments as follows:

(1) An image forming apparatus includes: an endless belt which is wound around a plurality of rollers and conveys a recording medium in a conveying direction, at least one of the plurality of rollers being rotationally driven; a plurality of image forming units which are provided for respective colors and sequentially form images on the recording medium conveyed by the endless belt in an overlap manner; a fixing unit which is provided at a downstream of the endless belt in the conveying direction, and thermally fixes the images formed by the image forming units to the recording medium; a first detection unit which detects a temperature of a roller closest to the fixing unit among the plurality of rollers; a second detection unit which detects a temperature of the endless belt; an error calculation unit which calculates an error of a conveying speed of the recording medium based on a difference between the detected temperatures by the first detection unit and the second detection unit immediately before the image forming units start image formation, and a number of a recording medium, on which images are next to be formed, from the start of the image formation; and a compensation unit which compensates the error calculated by the error calculation unit.

According to the configuration of (1), the error of the conveying speed due to thermal expansion and contraction of the endless belt is calculated based on the difference between the detection temperatures immediately before the image formation starts and the number of a next recording medium. For this reason, even though no sensor is provided in the endless belt, the error varying constantly can be favorably calculated and compensated, and occurrence of color shift can be favorably reduced.

(2) In the image forming apparatus of (1), the error calculation unit may calculate the error for an X-th recording medium from the start of the image formation by the expression: ΔV=(a·X−b)·ΔT−c·X+d, where a, b, and c are positive constants, d is a constant which is positive, negative or 0, and ΔT is the difference between the detected temperatures.

According to the configuration of (2), the error can be calculated by a simple primary expression, and thus a processing load can be reduced.

(3) In the image forming apparatus of (2), the error calculation unit may use the constants which are different according to a thickness of the recording medium.

If the thickness of the recording medium varies, the heat capacity or stiffness of the recording medium varies, and accordingly an influence on a change in temperature of the belt or an influence of belt expansion and contraction on the conveying speed of the recording medium also varies. For this reason, according to the configuration of (3), the error can be more accurately calculated and compensated by changing the variables in accordance with the thickness of the recording medium.

(4) In the image forming apparatus of (2), the error calculation unit may use the constants which are different according to a size of the recording medium.

If the size of the recording medium varies, the heat capacity or stiffness of the recording medium varies, and accordingly an influence on a change in temperature of the belt or an influence of belt expansion and contraction on the conveying speed of the recording medium also varies. For this reason, according to the configuration of (4), the error can be more accurately calculated and compensated by changing the variables in accordance with the size of the recording medium.

(5) In the image forming apparatus of (1) to (4), the compensation unit may change the conveying speed of the recording medium by adjusting a speed of the driven roller to compensate the error.

According to the configuration of (5), the errors for the respective colors can be collectively compensated by adjusting the speed of the endless belt.

(6) In the image forming apparatus of (1) to (4), the compensation unit may control positions of the images formed on the recording medium by adjusting a timing at which each of image forming units starts the image formation to compensate the error.

According to the configuration of (6), it is necessary to make the amount of the image forming timing to be adjusted for the respective colors different on the upstream side and the downstream side in the conveying direction of the recording medium, but such timing adjustment may be easily and rapidly performed by software.

(7) In the image forming apparatus of (1) to (6), the plurality of image forming units may be arranged in the conveying direction, and the second detection unit may be provided between the image forming unit at most upstream side and the image forming unit at most downstream side.

(8) In the image forming apparatus of (1) to (7), the error calculation unit may calculate the error only if the difference is more than a specific value.

(9) An image forming apparatus includes: an endless belt which is wound around a plurality of rollers and conveys a recording medium in a conveying direction; an image forming unit which forms an image on the recording medium conveyed by the endless belt; a fixing unit which thermally fixes the image formed on the recording medium; a first detection unit which is provided in a vicinity of a first roller closest to the fixing unit among the plurality of rollers and which detects a temperature of air in the vicinity of the first roller; a second detection unit which is provided at a position farther from the fixing unit than the first detection unit, and which detects a temperature of air in a vicinity of the endless belt; and a controller which controls a position of an image formed on the recording medium by the image forming unit based on a difference between the detected temperatures by the first detection unit and the second detection unit immediately before the image forming unit starts image formation and based on a number of the recording medium, on which an image is next to be formed by the image forming unit, from the start of the image formation.

(10) In the image forming apparatus according of (9), the controller drives at least one of the rollers to rotate the endless belt, and the controller may change a rotation speed of the at least one of the rollers to change a conveying speed of the recording medium on the endless belt based on the difference and the number of the recording medium, thereby controlling the position of the image formed on the recording medium.

(11) In the image forming apparatus of (10), if the number of the recoding medium exceeds a specific number, the controller may not change the rotation speed.

(12) In the image forming apparatus of (9), the controller may change a timing at which the image forming unit forms the image on the recording medium based on the difference and the number of the recording medium, thereby controlling the position of the image formed on the recording medium.

(13) In the image forming apparatus of (12), if the number of the recording medium exceeds a specific number, the controller may not change the timing.

What is claimed is:

1. An image forming apparatus comprising:
an endless belt which is wound around a plurality of rollers and conveys a recording medium in a conveying direction, at least one of the plurality of rollers being rotationally driven;
a plurality of image forming units which are provided for respective colors and sequentially form images on the recording medium conveyed by the endless belt in an overlap manner;
a fixing unit which is provided at a downstream of the endless belt in the conveying direction, and thermally fixes the images formed by the image forming units to the recording medium;
a first detection unit which detects a temperature of a roller closest to the fixing unit among the plurality of rollers;
a second detection unit which detects a temperature of the endless belt;
an error calculation unit which calculates an error of a conveying speed of the recording medium based on a difference between the detected temperatures by the first detection unit and the second detection unit immediately before the image forming units start image formation, and a number of a recording medium, on which images are next to be formed, from the start of the image formation; and
a compensation unit which compensates the error calculated by the error calculation unit.

2. The image forming apparatus according to claim 1,
wherein the error calculation unit calculates the error for an X-th recording medium from the start of the image formation by the following expression:
ΔV=(a·X−b)·ΔT−c·X+d
wherein a, b, and c are positive constants, d is a constant which is positive, negative or 0, and ΔT is the difference between the detected temperatures.

3. The image forming apparatus according to claim 2,
wherein the error calculation unit uses the constants which are different according to a thickness of the recording medium.

4. The image forming apparatus according to claim 2,
wherein the error calculation unit uses the constants which are different according to a size of the recording medium.

5. The image forming apparatus according to claim 1,
wherein the compensation unit changes the conveying speed of the recording medium by adjusting a speed of the driven roller to compensate the error.

6. The image forming apparatus according to claim 1,
wherein the compensation unit controls positions of the images formed on the recording medium by adjusting a timing at which each of image forming units starts the image formation to compensate the error.

7. The image forming apparatus according to claim 1,
wherein the plurality of image forming units are arranged in the conveying direction, and
wherein the second detection unit is provided between the image forming unit at most upstream side and the image forming unit at most downstream side.

8. The image forming apparatus according to claim 1,
wherein the error calculation unit calculates the error only if the difference is more than a specific value.

9. An image forming apparatus comprising:
an endless belt which is wound around a plurality of rollers and conveys a recording medium in a conveying direction;
an image forming unit which forms an image on the recording medium conveyed by the endless belt;
a fixing unit which thermally fixes the image formed on the recording medium;
a first detection unit which is provided in a vicinity of a first roller closest to the fixing unit among the plurality of rollers and which detects a temperature of air in the vicinity of the first roller;
a second detection unit which is provided at a position farther from the fixing unit than the first detection unit, and which detects a temperature of air in a vicinity of the endless belt; and
a controller which controls a position of an image formed on the recording medium by the image forming unit based on a difference between the detected temperatures by the first detection unit and the second detection unit immediately before the image forming unit starts image formation and based on a number of the recording medium, on which an image is next to be formed by the image forming unit, from the start of the image formation.

10. The image forming apparatus according to claim 9,
wherein the controller drives at least one of the rollers to rotate the endless belt, and
wherein the controller changes a rotation speed of the at least one of the rollers to change a conveying speed of the recording medium on the endless belt based on the difference and the number of the recording medium, thereby controlling the position of the image formed on the recording medium.

11. The image forming apparatus according to claim 10,
wherein if the number of the recoding medium exceeds a specific number, the controller does not change the rotation speed.

12. The image forming apparatus according to claim 9,
wherein the controller changes a timing at which the image forming unit forms the image on the recording medium based on the difference and the number of the recording medium, thereby controlling the position of the image formed on the recording medium.

13. The image forming apparatus according to claim 12,
wherein if the number of the recording medium exceeds a specific number, the controller does not change the timing.
